(19) United States
(12) Patent Application Publication
(10) Pub. No.: US 2002/0053894 A1
(43) Pub. Date: May 9, 2002

(54) Discrete-time system and method for induction motor control

(76) Inventors: Serge L. Shishkin, Altamonte Springs, FL (US); Donald C. Wunsch II, Rolla, MO (US)

Correspondence Address: William A. Blake, Jones, Tullar & Cooper, P.C., P.O. Box 2266 Eads Station, Arlington, VA, 22202, US

(21) Appl. No.: 09/867,694

(22) Filed: May 31, 2001

Related U.S. Application Data
(60) Provisional application No. 60/208,042, filed on May 31, 2000.

(51) Int. Cl. H02P 1/24; H02P 1/42; H02P 3/18; H02P 5/28; H02P 7/36

(52) U.S. Cl. 318/727

(57) ABSTRACT

A simple and robust discrete-time induction motor control technique employs a control algorithm that estimates load torque and rotor resistance from the measured rotor velocity of the motor to be controlled. The estimates of load torque and rotor resistance are employed to generate periodic estimates of parameters that are employed to control first and second harmonic signal generators. A switch controls which of the signal generators supplies a control signal to the motor at any given moment. The two signal generators work in turn such that while one produces the motor control signal, the other one is being readjusted to the new set of parameters by the parameter controller. The control method can be considered as a generalization and modification of Field Oriented Control. In a “non-adaptive” modification, it ensures global exponential stability of a closed-loop system, if at least local stabilization of the system by static control is possible, for given parameter estimates. In an adaptive version, it provides identification and global exponential stabilization of the system.

### PRIORITY CLAIM UNDER 35 U.S.C. 119 (e)

This application claims the benefit, under 35 U.S.C. 11 9(e), of U.S. Provisional Application No. 60/208,042, filed May 31, 2000.

### BACKGROUND OF THE INVENTION

1. Field of the Invention

The present invention relates in general to a control technique for regulating velocity and rotor flux of an induction motor. The rotor flux is assumed unmeasurable, load torque and rotor resistance may be unknown and time-varying, with small non-differentiable disturbances present. A simple and robust discrete-time control technique is employed that can be considered as a generalization and modification of Field Oriented Control.

2. Description of the Background Art

The problem of control of an induction motor has been under active investigation in recent years. It is motivated by numerous industrial applications and presents a challenging control problem. The dynamic model of the system is non-linear; two of the state variables (rotor flux) are usually not measurable as it is difficult and costly to measure them. and, due to ohmic heating, the rotor resistance varies considerably with corresponding significant effects on dynamics of the system. In particular, as the rotor resistance slowly varies, small but non-differentiable disturbances may be present in control and observation channels. “Indirect Field-Oriented Control” is considered as the most advanced up-to-date induction motor control technique. While there exist different methods to identify the induction control parameters—rotor resistance and load torque—in the frame of Indirect Field-Oriented Control, these methods are rather complicated and need significant amount of calculations, which makes difficult or costly to use them on-line. Besides, these techniques are somewhat auxiliary to the core Indirect Field-Oriented Control algorithm.

### SUMMARY OF THE INVENTION

The present invention provides a system and method for controlling an induction motor that employs a new control algorithm. The main differences from the conventional known control technique are the following. First, the control is very simple to implement, much cheaper and simpler than “Indirect Field-Oriented Control.” Second, it is more accurate and robust. Third, it includes identification of the induction control parameters - rotor resistance and load torque. At the same time, identification of these parameters is performed in a natural and straightforward manner. As numerical simulations have shown, the algorithm presents an excellent performance even in very complex control situation (tight restrictions on control signal, instant changes of the motor parameters). Together with other advantages, the it makes the suggested algorithm far excelling any other existing control technique for induction motor.

The method of the present invention that implements the subject algorithm operates in the following manner. First, the rotor velocity of an induction motor to be controlled is measured and used with specific equations to estimate the present values of the rotor resistance and load torque. Preferably, a “Least-Square” optimization method is employed to solve the equations and determine these values, although any other suitable method could also be employed. Next, the estimates of rotor resistance and load torque are employed to calculate the values of three constants (amplitude, frequency and phase) to control a pair of harmonic signal generators that each generate a motor control signal. A switch is provided that alternates between first applying the control signal from the first generator to the motor, and then applying the control signal from the second generator to the motor. A parameter controller operates in conjunction with the switch in such a manner that updates of the parameters are only applied to the one of the signal generators that is not currently applying its control signal to the motor so that the two signal generators and work in turn. While one produces the control signal that is fed to the motor, the other one is being readjusted to the new set of parameters by the parameter controller. Then, at discrete time periods, the switch changes its position, and the one of the generators which was being readjusted, becomes the “working” one, and vice versa. The intervals between switches are regular and made as short as necessary to allow readjustment of the generators, which need some small time after the constants are set, to reach the “working regime” and, possibly, other necessary time expenses.

In a modification of the invention that is applicable if the load torque of the motor is known to be negligibly small, the parameter controller is not needed. Instead, the switch works not at regular time periods, but at the moments when the deviation of measured rotor velocity from the desirable value exceeds some fixed value.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a schematic block diagram illustrating an induction motor control system that is constructed in accordance with a preferred embodiment of the invention;

FIGS. 2A-2D are graphs showing values as a function of time of four motor parameters during experiments to test the effectiveness of the control algorithm of the present invention, these parameters being load torque, rotor resistance, flux norm and rotor velocity, respectively;

FIG. 3 is a table showing the experimental results of speed and flux values for six different experiments;

FIG. 4A-4D are graphs depicting experimental results, with FIGS. 4A, 4B and 4D showing rotor flux and velocity as a function of time for experiment numbers 1, 2 and 6, respectively, and FIG. 4B showing motor voltage and current as a finction of time for experiment number 1;

to FIG. 5 is a graph depicting rotor trajectory as a function of time in a seventh experiment designed to track the rotor trajectory and minimize least-square deviation of |x (t)| from β; and

FIG. 6 is a graph depicting rotor position and flux as a function of time for another experiment.

### DETAILED DESCRIPTION OF A PREFERRED EMBODIMENT

1. Problem Formulation

To understand the theory behind the novel control algorithm that is employed in the preferred embodiment of the present invention, the dynamic model of a current fed induction motor needs to be considered first. In its simplest formulation, with disturbances added to all channels, the model takes the form:

$$\begin{matrix}\dot{x} = Rx + Ru + {ξ}_{1} , & ( 1 ) \\ \dot{y} = {u}^{T} Jx - τ + {ξ}_{2} , & ( 2 ) \\ \hat{y} = y + {ξ}_{3} , & ( 3 )\end{matrix}$$

where

$$x = [ \begin{matrix}{x}_{1} \\ {x}_{2}\end{matrix} ] ε {IR}^{2}$$

is the rotor flux vector

$$u = [ \begin{matrix}{u}_{1} \\ {u}_{2}\end{matrix} ] ε {IR}^{2}$$

are the stator currents, τ is the load torque, R is the rotor resistance, y and

$$\hat{y}$$

are the true and measured rotor velocity respectively, ξ₁, ξ₂, ξ₃ are non-differentiable, nonmeasurable disturbances,

$$J = [ \begin{matrix}0 & - 1 \\ 1 & 0\end{matrix} ] .$$

The values of R and τ may be unknown.

To simplify the expressions below, and without loss of generality for the purposes of this analysis, all motor parameters have been set to unity except rotor resistance and load torque.

One goal of the subject invention's control algorithm is to provide global exponential stability of a closed-loop system within some accuracy δ=δ(δ₁, δ₂, δ₃):

||x(t)|−β|<Kₓ||x(O)|+C|e^{-vt}+O(δ), (4)

|y(t)−d|<K_{y}|y(O)−d|e^{-vt}+O(δ), (5)

where d and β are desired values of rotor velocity and flux norm respectively, t ∈ [0, ∞), Kₓ, K_{y}, C, v are positive constants.

Assumption The disturbances ξ₁, ξ₂, ξ₃, are supposed to be bounded by some small known constants such that:

|ξ₁|<δ₁, |ξ₂|<δ₂, |ξ₃|<δ₃. (6)

In particular we assume max (δ₁/Rβ, δ₂/β²)<<1.

Note that the algorithm below is applicable as well if the disturbances are unbounded stochastic processes with zero mean and small dispersion.

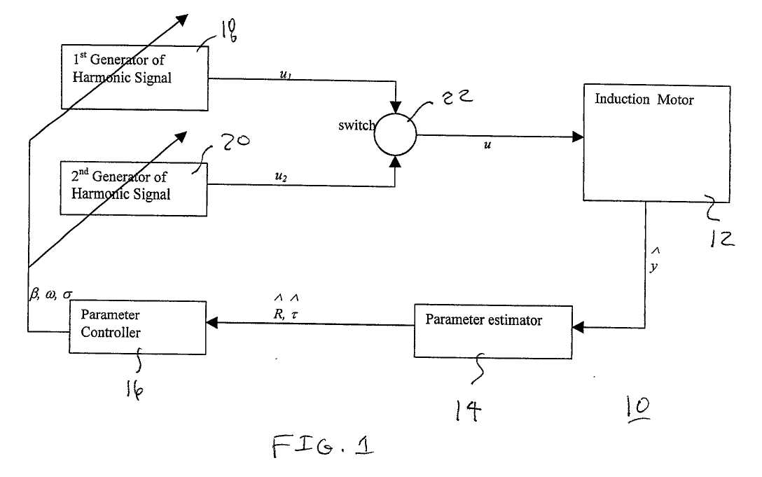

The remaining of the detailed description is organized as follows. In the next section, it is shown that, if load torque is not negligible, identification of the value of rotor resistance is required for any static control. The section also discusses limitation of robustness of Indirect Field Oriented Control. In Section 3, the main idea of the subject control method is briefly described, then presented formally its exponential stability is proven. In Section 4, the particular case of small load torque is considered, and robust non-adaptive modification of the subject algorithm is presented. An exemplary implementation of the invention is discussed in Section 5 with reference to FIG. 1. Section 6 is devoted to the results of a numerical simulation that was conducted to verify. The proofs of all Lemmae and Theorems are presented in the Appendix at the end of the description.

2. Limitations on Robustness and Necessity of Identification

The subject control algorithm is adaptive, i.e. it includes an identification block for the parameters R, τ. The following Lemma shows that such identification is unavoidable for any static control algorithm.

Lemma 1 Let δ=0. If two systems of the form (1)-(2) with different pairs of parameters (R₁,τ₁)≠(R₁,τ₂) can be locally stabilized by the same control of the form u=u (x, y), that is, if the condition

$${lim}_{t -> ∞} y ( t ) = d , {lim}_{t -> ∞} \vert x ( t ) \vert = β \qquad ( 7 )$$

is providedfor the both systems, then τ₁=τ₂=0.

We see that Lemma 1 allows the control algorithm to use exact values of rotor flux x. Thus, even direct measurability of rotor flux (which is not the case usually) can not eliminate the necessity of parameter estimation unless load torque is negligible.

Now, let us consider Indirect Field-Oriented Control—the most popular up-to-date technique for regulation of an induction motor:

$$u = {e}^{Jp} [ \begin{matrix}β \\ τ d / β\end{matrix} ] , \dot{p} = \frac{\hat{R}}{{β}^{2}} τ d , \qquad ( 8 )$$

τ_{d}=−(Kp+p⁻¹K_{I})(y−d). (9)

where Kₚ, K_{I} are some constants, p=d/dt. Technically speaking, the control (8)-(9) does not satisfy the assumption of Lemma 1 as it uses the dynamical variable p. However, the same deduction is applicable to it:

Lemma 2 Let δ=0. If \hat{R}≠R, τ≠0, then the control algorithm (8)-(9) cannot provide the condition (7) for the system (1)-(2) even locally.

The Lemma 2 does not contradict the fact that the Indirect Field-Oriented Control stabilizes the system (1)-(2); however, it states that the equilibrium depends on \hat{R}, τ. Therefore, the control objective will not be fulfilled if \hat{R}≠R.

We see that most of the known control algorithms for the system (1)-(2) can be robust only if τ is negligible. It will be shown that, in this case, our control is robust, that is, the control objective (4)-(5) is provided without estimation of the rotor resistance R.

3. Control Algorithm

In this section we present a new control algorithm for solving the problem (4), (5). We call it Harmonic Control for reasons clear from its formula below.

The main idea of the algorithm may be described as follows. Let us consider a disturbance-free case: ξ₁=ξ₂=ξ₁=0. When the motor reaches its desirable regime x²=β², y=d, system dynamics (1)-(2) imply (see Proof of Lemma 1) that

u(t)=(I+(τ/β²)J)x(t),

x(t)=(Rτ/β²)Jx(t).

Thus both x and u have the form

$$x = β [ \begin{matrix}cos ( {ω}_{i} t + {σ}_{x} ) \\ sin ( {ω}_{i} t + {σ}_{x} )\end{matrix} ] , {ω}_{i} = Rτ / {β}^{2} , \\ u = β \sqrt{1 + {ω}_{i}^{2} / {R}^{2}} [ \begin{matrix}cos ( {ω}_{i} t + {σ}_{u} ) \\ sin ( {ω}_{i} t + {σ}_{u} )\end{matrix} ] . \qquad ( 10 )$$

Moreover, if we define u in the form (10) then x², x^{T} u will exponentially converge to desirable values β, τ accordingly. To provide a desirable value of y as well, we only need to increase or decrease ω₁ for a limited period of time.

Our control algorithm can be considered as discrete-time one: like any discrete-time algorithm, it checks the output and sets a new control once in some “time step” Δt; however, the control is not piecewise-constant but “piecewise-harmonic”:

$$u ( t ) = {v}_{i} [ \begin{matrix}cos ( {ω}_{i} ( t - {t}_{i} ) + {σ}_{i} ) \\ sin ( {ω}_{i} ( t - {t}_{i} ) + {σ}_{i} )\end{matrix} ] , \begin{matrix}t ε [ {t}_{i} , {t}_{i + 1} ] \\ i ε N ,\end{matrix} \qquad ( 11 )$$

where v₁, w₁, t₁, σ₁ are piecewise-constant scalar parameters of the control algorithm, defined by:

$$\begin{matrix}{t}_{1} = 0 , {t}_{i + 1} = {t}_{i} + Δ t ; i = 1 , … , \\ {ω}_{i} \frac{\hat{R \hat{τ}}}{{β}^{2}} + \{ \begin{matrix}{ω}_{+ ,} \\ 0 , \\ ω\_ ,\end{matrix} \begin{matrix} if \hat{y} < d - ϵ , \\ if \vert \hat{y} - d \vert \leq ϵ , \\ otherwise ,\end{matrix} & ( 12 ) \\ {v}_{i} = β \sqrt{( 1 + {ω}_{i}^{2} / {\hat{R}}^{2} ) ;} & ( 13 ) \\ {σ}_{i} = {σ}_{i - 1} + {ω}_{i - 1} ( {t}_{i} - {t}_{i - 1} ) + arcsin \frac{{ω}_{i}}{\sqrt{{\hat{R}}^{2} + {ω}_{i}^{2}}} - arcsin \frac{{ω}_{i - 1}}{\sqrt{{\hat{R}}^{2} + {ω}_{i - 1}^{2}}} . & ( 14 )\end{matrix}$$

Here \hat{R}, \hat{τ} are estimates of the parameters R, τ accordingly, ω+ω_ are positive control parameters chosen by the user from engineering reasons, Δt is “time step”. The greater that the parameters ω₊, ω₋ are, the faster the rotor speed achieves the desirable value, but the greater the “transfer” values of currents and voltages that are needed.

The proposed control, as defined by equations (1 l)-(14), is piecewise-continuous. This seemingly contradicts the fact that real motor currents are continuous. To implement the control (11)-(14), we must simulate “jumps” of ω (say, from ω₊ to \hat{R} \hat{τ}/β²) and corresponding “jumps” of υ, σ by fast but gradual changes (relationships (13), (14) must hold all of the time). We will see below that this modification does not alter the properties of Harmonic Control.

The identification algorithm for \hat{R}, \hat{τ} is based on the following Lemma.

Lemma 3 For any i ∈ N, τ ∈ [tₗ, t₁], the system (1)-(3), (14) s atisfies the conditions:

$$\begin{matrix}x ( t ) = {e}^{- R ( t - {t}_{i} )} {x}_{i} + {\int }_{{t}_{i}}^{t} {e}^{- R ( t - s )} {ξ}_{1} ( s ) ⅆ s + \frac{{Rv}_{i}}{{R}^{2} + {ω}_{i}^{2}} [ \begin{matrix}R cos {α}_{i} ( t ) + {ω}_{i} sin {α}_{i} ( t ) \\ R sin {α}_{i} ( t ) - {ω}_{i} cos {α}_{i} ( t )\end{matrix} ] & ( 15 ) \\ y ( t ) = \frac{- {v}_{i}}{{R}^{2} + {ω}_{i}^{2}} {( {e}^{- R ( t - {t}_{i} )} {q}_{i} ( t , R ) - {q}_{i} ( {t}_{i} , R ) )}^{T} {x}_{i} + \hat{y} ( {t}_{i} ) + ( \frac{{Rv}_{i}^{2} {ω}_{i}}{{R}^{2} + {ω}_{i}^{2}} - τ ) ( t - {t}_{i} ) + ξ ( t ) \\ where {α}_{i} ( t ) = {ω}_{i} ( t - {t}_{i} ) + {σ}_{i} , & ( 16 ) \\ {q}_{i} ( t , R ) = [ \begin{matrix}{ω}_{i} cos {α}_{i} ( t ) + R sin {α}_{i} ( t ) \\ - R cos {α}_{i} ( t ) + {ω}_{i} sin {α}_{i} ( t )\end{matrix} ] \\ {x}_{i} = x ( {t}_{i} ) - \frac{{Rv}_{i}}{{R}^{2} + {ω}_{i}^{2}} [ \begin{matrix}R cos {σ}_{i} ( t ) + {ω}_{i} sin {σ}_{i} ( t ) \\ R sin {σ}_{i} ( t ) - {ω}_{i} cos {σ}_{i} ( t )\end{matrix} ] \\ ξ ( t ) is some disturbance such that \\ \vert ξ ( t ) \vert \leq δ ( t - {t}_{i} ) , δ ( t ) = {δ}_{2} t + {v}_{i} {δ}_{1} t + {δ}_{3 ,} t \geq 0. & ( 17 )\end{matrix}$$

Estimates \hat{R}, \hat{τ} now can be obtained on-line from (3), (16) by the Least-Square fit. After a number of successive “time steps” tₗ . . . , tₗ₊ₖ when the values of the parameters υ, ω were kept constant, we can define

$$( \hat{R} , \hat{τ} , {\hat{x}}_{i} ) = arg {min}_{R , τ , x} {\sum }_{j = 1}^{N} {f}^{2} ( {s}_{j} , R , τ , x ) , \qquad ( 18 )$$

where s₁, . . . , s_{N} are moments on the interval [tₗ, tₗ₊ₖ] when samples of ŷ were taken,

$$f ( s , R , τ , {x}_{i} ) = y ( s ) - \hat{y} ( {t}_{i} ) - ( \frac{{Rv}_{i}^{2} {ω}_{i}}{{R}^{2} + {ω}_{i}^{2}} - τ ) ( s - {t}_{i} ) + \frac{{v}_{i}}{{R}^{2} + {ω}_{i}^{2}} {( {e}^{- R ( s - {t}_{i} )} {q}_{i} ( s , R ) - {q}_{i} ( {t}_{i} , R ) )}^{T} {x}_{i} .$$

Notice that the function ƒ is linear with respect to τ, x thus (18) is equivalent to minimization of some scalar function.

It can be shown that the estimates obtained by (18) are numerically stable; however accurate estimation of R is possible only if ω becomes negligible too as soon as the desirable value of d is achieved. Fortunately, in that case, we do not need to estimate R, which is shown in the next section.

It follows from Lemma 1, that, if τ is not negligible, then an identification block should be used anyway. Thus we suppose that, when the i^{th} step is completed, the identification block provides

|τ−\hat{τ}|≦O(δ_{id}),

|R−\hat{R}|≦O(δ_{id}), (19)

where δ_{id} is the identification error. If we use the Least-Square estimation method, δ_{id} should have an order O(δ(Δτ)); if the parameters R, τ are known, then of course δ_{id}=0.

Theorem 4 If the conditions (19) are valid and ω₊,ω₋ are big enough, then

||x(t)|−β|<|x₁|e^{-Rt}+O(δ_{id}+δ₁Δt), |y(t)−d|<∈+δ₃+O(Δt).

Now we see why replacing “jumps” of ω, υ by fast changes cannot affect closed-loop stability. Such a period of “transfer” from one control regime to another should be relatively short, and identification of R, τ can be turned off during this time without violating (19). From the proof of Theorem 4 we see that, as long as ω−Rh/β² has the correct sign and υ, σ satisfy (13)-(14)—which is the case—the values |x|, y converge to β, d, respectively.

We also see that the parameters R, τ may vary slowly in time: if their drift has order O(δ_{id}) per unit time then the identification block will modify the estimates \hat{R}, \hat{τ} and still will provide (19).

We can easily derive a continuous-time form of our algorithm by setting Δt “infinitely small” and generalizing the formula (12) for a. We obtain:

$$u ( t ) = β \sqrt{1 + {ω}^{2} ( t ) / {\hat{R}}^{2}} [ \begin{matrix}cos ( σ ( t ) ) \\ sin ( σ ( t ) )\end{matrix} ] , \\ σ ( t ) = \hat{( R} / \sqrt{{\hat{R}}^{2} + {ω}^{2} ( t ) )} ω ( t ) + ω ( t ) ; \\ ω ( t ) = F ( \hat{y} - d ) , t \geq 0 \qquad ( 20 )$$

where F is some function, which will provide vanishing of |y−d|—for example, (I12). Now, if we denote:

$$ρ = σ - arc sin \frac{ω}{\sqrt{{\hat{R}}^{2} + {ω}^{2}}} , {τ}_{d} = \frac{ω}{\hat{R}} {β}^{2} ,$$

we obtain the formula of Indirect Field-Oriented Control (8). The definition (9) is just another possible variant for the function F.

A closed-looped system with continuous-time control (20) also satisfies Lemma 3 and Theorem 4 as no limitation was imposed on the value of Δτ. It means that estimation (18) of motor parameters is still applicable as long as parameter ω is kept constant for some time. It also implies stability of the closed-looped system for the control (20), (12).

It should be noted that this approach—via discrete-time form of the control—may be a convenient tool for analysis of stability properties of Indirect Field-Oriented Control and its modifications.

In conclusion to the section, let us note that Lemma 3 gives us a tool not only for estimation of the parameters R, τ but also for the prediction vector x(tₗ) and trajectory x(t), t ∈ [tₗ, tᵢ₊ₗ]. Based on this predictor, the control for the next time interval can be calculated in advance. If we have two simple generators of harmonic signals, one generator can provide a motor control input signal, while the other can be adjusted to the values υₗ₊₁, ωₗ₊₁, σₗ₊₁; then at the moment tₗ₊₁ they are switched. By this way any delay in control can be avoided. A detailed discussion of such an implementation is provide in Section 5.

4. Small Load Torque

Now consider the case when the value τ of load torque is small and bounded by a small known constant δ_{τ}. In this situation, Lemmae 1,2 are not applicable, hence the possibility of robust control cannot be ruled out. Indeed, we can slightly modify the control algorithm (11)-(14) such that for small τ global stability of a closed-loop system can be achieved without parameter identification.

Let the control still have the form (11) but the parameters υₗ, ωₗ, τₗ, σₗ be defined, instead of (12)-(14), by the following formulae:

$${t}_{2 i} = min \{ t > {t}_{2 i - 1} / \hat{y} = d \} ; {t}_{1} = 0$$

$${t}_{2 i + 1} = min \{ t > {t}_{2 i} / \vert \hat{y} - d \vert = ϵ \} ; i ∈ N ;$$

$${ω}_{i} = \{ \begin{matrix}sign ( d - \hat{y} ( {t}_{i} ) ) {ω}_{0} , & if i = 1 , \\ 0 , & if i is even , \\ sign ( d - \hat{y} ( {t}_{i} ) ) {ω}_{*} , & otherwise ;\end{matrix} \\ {σ}_{i} = {ω}_{i - 1} ( {t}_{i} - {t}_{i - 1} ) + {σ}_{i - 1 ,} {σ}_{1} = 0 ; \\ {v}_{i} = \{ \begin{matrix}\frac{\sqrt{{\hat{R}}_{0}^{2} + {ω}_{0}^{2}}}{{\hat{R}}_{0}} β , & if i = 1 , \\ β & otherwise .\end{matrix} \qquad ( 21 )$$

The parameters \hat{R}₀, ω₀, ω_{*}, ∈ should be chosen by the user within the range:

$$ϵ > 0 ; {R}_{min} \leq \hat{R} \leq {R}_{max} ;$$

$${ω}_{0} \geq \frac{{R}_{max}}{{β}^{2}} {( \frac{{\hat{R}}_{0}}{{R}_{min}} )}^{2} τ ; \\ \frac{2 ( {δ}_{2} + τ )}{{β}_{2} + \sqrt{{β}^{4} - 4 {( {δ}_{2} + τ )}^{2}}} {R}_{max} \leq {ω}_{*} \leq \frac{2}{3 in 3} {R}_{min} . \qquad ( 22 )$$

where Rₘᵢₙ, Rₘₐₓ are known lower and upper bounds for R respectively.

The control works as follows: the first “step” [t₁, t₂] brings both |x| and y in a neighborhood off β and d accordingly. Then at even “steps” [t₂ᵢ, t₂ᵢ₊₁] the value ||x|−β| decreases exponentially to the level δ₁ while |y−d| changes with a speed not exceeding τ+δ₂. At odd “steps” the value |y−d| decreases linearly to the level δ₃ while |x| stays in some O(ω_{*}) neighborhood off β. The following theorem gives a formal statement:

Theorem 5 Let the conditions (22) hold. Then the closed loop system (1)-(3), (11), (21) is satisfied to the conditions:

$$\begin{matrix}\vert \vert x ( t ) \vert - β \vert \leq \vert \vert x ( 0 ) \vert + C \vert {e}^{- Rt} + \frac{2 {βω}_{*}}{\sqrt{{R}^{2} + {ω}_{*}^{2}}} + {δ}_{1} , & ( 23 ) \\ \vert y - d \vert \leq ϵ + {δ}_{3} , & ( 24 )\end{matrix}$$

where C is some constant depending on β, \hat{R}₀, ωₒ.

The meaning of the parameters ω_{*}, ∈ is clear from the Theorem 5: they define the accuracy of the limit regime of the motor. However they also have another function: the smaller ω_{*} is, the slower y drives to d at even “steps”; the smaller ε the more rarely |x| gets chances to get closer to β than guaranteed boundaries (23). Thus the choice of parameters ∈, ω_{*} is a tradeoff. We recommend to choose ∈≧δ₃. The parameter \hat{R}₀ is just an initial estimate of R; ω₀ is to be chosen as large as practically reasonable.

Naturally, not only the first “step” [t₁, t₂] but several first “steps” can be made to bring |x|, y closer to β, d. For this purpose we should update the estimate \hat{R} and choose the parameters of the control (11) as ω=ω₀,

$$v = \frac{\sqrt{{\hat{R}}^{2} + {ω}_{0}}}{\hat{R}} β .$$

Obviously, the statement of Theorem 5 is still valid in this case.

Notice the control (21) after the first “step” is continuous and piecewise-differentiable.

5. Exemplary Implementation

With reference to FIG. 1, a motor control system 10 is illustrated that is constructed in accordance with the preferred embodiment of the invention. The control system 10 controls operation of an induction motor 12 in response to a measured rotor velocity signal ŷ received from the motor 12. The rotor velocity signal ŷ is input to a parameter estimator 14 that uses this value and the current values of β, ω, σ with equation (16) to generate (e.g., using a software-based algorithm) estimates of the rotor resistance R and load torque τ. There are several ways that this can be done; the simplest is to use the “Least-Square” optimization method as discussed previously.

After the estimates of rotor resistance R and load torque rare generated, they are fed to a parameter controller 16 that uses the estimates with equations (12)-(14) to calculate the parameters δ, ω, σ (again, using a software-based algorithm, for example). These parameter values are then fed to first and second conventional harmonic signal generators 18 and 20, each of which employ the constants β, ω, σ to generate a two-component harmonic control signal, μ₁ and μ₂, respectively. The components of μ₁ and μ₂ are β sin(ωt+σ) and β cos(ωt+σ). A switch 22 is provided to apply either μ₁ or μ₂ as the motor control signal μ.

The control system 10 works as follows. The rotor velocity of the motor 10 is continually measured and applied to the parameter estimator 14, which generates the estimates of load torque and rotor resistance using equation (16). The estimates of load torque and rotor resistance are then applied to the parameter controller 16, which periodically generates values for the parameters and applies them to the first and second control signal generators 18 and 20. The parameter controller 16 operates in conjunction with the switch 22 in such a manner that updates of the parameters are only applied to the one of the signal generators 18 or 20 that is not currently applying its control signal to the motor 12. In other words, the two signal generators 18 and 20 work in turn. While one produces the signal μ which is fed to the motor 12, the other one is being readjusted to the new set of parameters by the parameter controller 16. Then, at discrete time periods tₗ, the switch 22 changes its position, and the one of the generators 18 and 20 which was being readjusted, becomes the “working” one, and vice versa. The intervals between switches are regular and made as short as necessary to allow readjustment of the generators, which need some small time after the constants β, ω, σ are set, to reach the “working regime” and, possibly, other necessary time expenses (for example, the delays which may be caused by the parameter controller 16 and parameter estimator 14).

If the load torque r of the motor is known to be negligibly small, the control modification described in Section 4 can be used. In such case the parameter controller 16 is not needed. Instead, the switch 22 works not at regular time periods, but at the moments when the deviation of measured rotor velocity from the desirable value exceeds some fixed value ε.

6. Numerical Simulations

The quality of the control algorithm that forms the heart of the invention was checked by a number of numerical simulations. As a base for these simulations, a benchmark model disclosed in “A Benchmark for Induction Motor Control” by R. Ortega et al. was used which is a classical induction motor model with the following parameter values:

Stator Inductance (Lₛ)-0.47H

Rotor Inductance (Lpₛ)-0.47H

Mutual Inductance (Lₛᵣ)-0.44H

Total Leakage Factor (σ)-0.12

Stator Resistance (Rₛ)-8.0 Ohms

Rotor Resistance (Rᵣ)-3.6 Ohms

Moment of Inertia (Dₘ)-0.06Kg-m²

Number of Pole Pairs (nₚ)-2

When the equations set forth in Ortega et al. are transformed in the form (1), (2), the parameters of the model take the nominal values:

τ=Lᵣτ_{L}/nₚ=1.645N−m−H, R=Rᵣ/Lᵣ=7.66 Ω/H, d=DₘLᵣωₙₒₘ/np=_{1.034Kg-m}²_{H/sec, β=}1.14Wb. (25)

Further, we will refer the values (25) as “nominal” values Rₙₒₘ, τₙₒₘ, dₙₒₘ, βₙₒₘ.

In all experiments rotor flux was assumed to be unmeasurable. Disturbances ξ₁, ξ₂, ξ₃ were simulated as random Gaussian signals with dispersions σ₁, σ₂, σ₃ accordingly. In addition, the following modifications of the control algorithm (11)-(14) were assumed:

1. When value β changed instantly, in the formula (13), we used an “approximate” value off β, which changed gradually.

2. Instant changes of d were taken into account in advance, and the control changed a little bit earlier than they actually occurred.

3. The equation (12) was slightly modified so that the value of ω did not “jump” instantly but started to grow or decrease gradually. Then it slowed down just before reaching \hat{R} \hat{τ}/β².

Each time, the machine started with all initial conditions equal to zero, and worked for 10 seconds. The values of stator currents and voltages during the experiments were computed using formulae from Ortega et al. In the experiments when τ was unknown, the initial estimate of it was equal to τₙₒₘ, while the true initial value of the parameters was 0.5 τₙₒₘ.

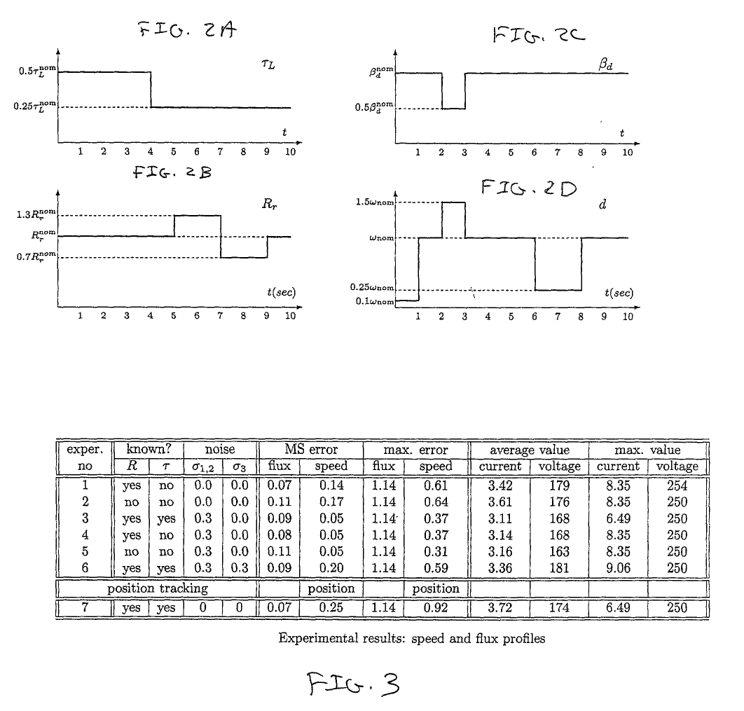

In all but one experiment, the control objective was to track given time-varying values of d, β. The parameters R, τ were also non-stationary. Dependence of reference parameters on time is shown on FIGS. 2A-2D. We experimented combining the following settings:

Parameter τ is known/unknown;

Parameter R is known/unknown;

Noise dispersions (σ₁=σ₂=0/σ₁=σ₂=0.1 (in corresponding units);

Noise dispersion σ₃=0 Kg−m²−H/sec/σ₃=0.1 Kg.m²−H/sec;

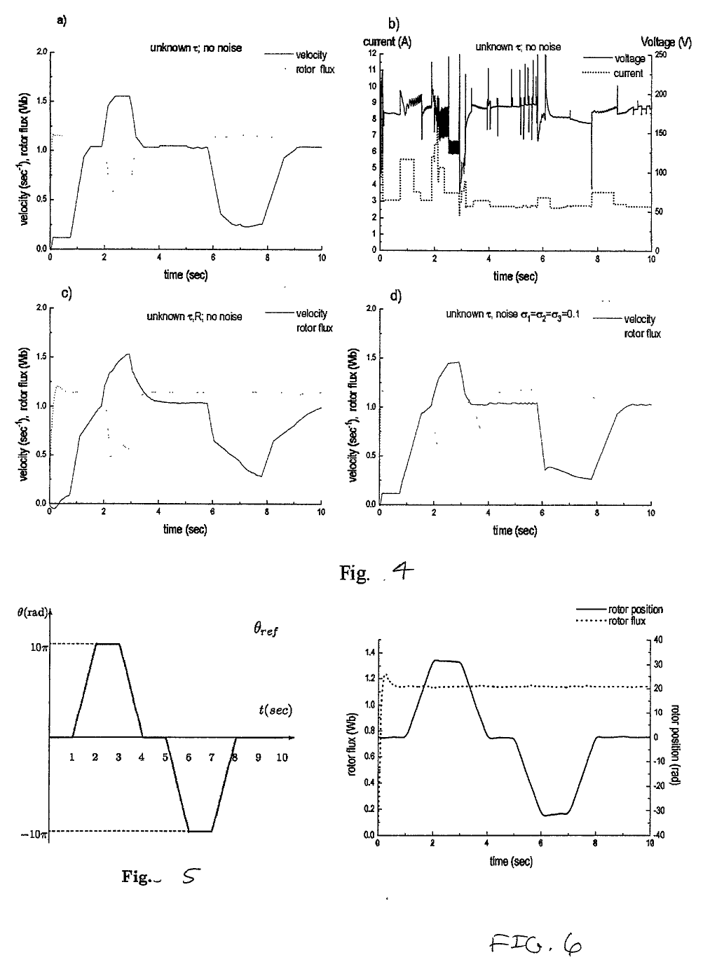

For this control objective, six experiments were conducted. Their results—maximal and mean square values of errors ||x|−β|, |y−d|, as well as those of currents and voltages are presented in the table of FIG. 3. FIGS. 4A, 4C and 4D shows dependence of |x|, y on time for experiments 1, 2 and 6, respectively, while FIG. 4B is a graph of currents and voltages versus time for experiment 1. We can see that the subject invention's algorithm reliably provides tracking of β(t), d(t). In experiments 3 and 6, a decrease of y after 6 sec slowed down too early because the control system got confused either by an inaccurate estimate of τ or by disturbed measurements of y; but in both cases y was brought back on desirable trajectory within 1 sec.

The variations of |x| from fl at the moments 5, 7, 9 are due to instant changes of the parameter R. In the case when the value R is known, it is easy to eliminate these variations completely by compensating control changes. However, we consider the case of rapid changes of R known to the control system in advance as rather exotic and because of that do not sophisticate our control algorithm.

In the 7^{th} experiment, the control objective was to track a given trajectory of the rotor,

$$θ ( t ) = {\int }_{0}^{t} y ( s ) ⅆ s ,$$

(shown in FIG. 5) and to minimize least-square deviation of |x(t)| from β.

The parameters R, τ, β were assumed to be constant:

R=Rₙₒₘ, τ=0.5 τₙₒₘ, β=βₙₒₘ.

It should be noted that the subject method was designed for other goals than position tracking. Because of that, we had to add some empirical control block for “fine tuning” of position. We can see in the table of FIG. 3 and the graph of FIG. 6, that the subject invention's harmonic control technique can handle this control objective, but doubtlessly its performance can be improved if it is modified specially for this problem.

Summarizing the results of experiments, we can conclude that our method demonstrated efficient, robust and accurate performance for all tested settings.

In conclusion, the subject invention's control method is fairly simple: it can be implemented by two harmonic signal generators and one switch. Due to this simplicity, a trajectory of unmeasurable state variable is easily predictable and motor parameters are identifiable.

The control provides global exponential stability of the closed-loop system. It is robust with respect to deviations of motor parameters if the load torque is negligible; it is shown that this is the only case when any static or field-oriented control can be robust for the given model.

“Harmonic Control” belongs to the discrete-time type of control methods; however it easily allows for continuous-type modification, which can be considered as a generalization of Indirect Field-Oriented Control. Thus the subject invention may be used for theoretical analysis of the latter method. The proposed approach can also be useful for design optimal control of induction motors. Finally, the experiments confirm accuracy, efficiency and robustness of the proposed “Harmonic Control” technique.

Although the invention has been disclosed in terms of a preferred embodiment, and modifications thereon, it will be understood that numerous additional variations and modifications could be made thereto without departing from the scope of the invention as defined in the following claims.

APPENDIX

Proof of Lemma 1.

Let us consider any trajectory of the system (1)-(2) satisfying (7). The limit set of this trajectory will be a trajectory of (1)-(2) as well. Let x(t), y(t), u(t) be system state, output and control respectively along this limit trajectory, t ∈ IR.

Obviously, (7) implies

x²(t)≡β, y(t)≡0 for all t ∈ IR, (26)

hence it follows from (1)-(2) that for any t ∈ IR

$${u}^{T} ( t ) x ( t ) = {( 2 R )}^{- 1} \frac{ⅆ}{ⅆ t} {x}^{2} ( t ) + {x}^{2} ( t ) = {β}^{2}$$

u^{T}(t)Jx(t)=y(t)+τ=τ.

For all t ∈ IR, the vectors x(t) and Jx(t) form a basis in IR², and we can decompose u(t) in this basis as

$$u ( t ) = \frac{{u}^{T} x}{{x}^{2}} x + \frac{{u}^{T} Jx}{{x}^{2}} Jx = ( I + ( τ / {β}^{2} ) J ) x ( t ) . \qquad ( 27 )$$

The function x(t) is differentiable, hence the function u(t) is differentiable too, and from (1),(27) we obtain:

$$\begin{matrix}u ( t ) = ( I + ( τ / {β}^{2} ) J ) x ( t ) \\ = R ( I + ( τ / {β}^{2} ) J ( u ( t ) - x ( t ) ) \\ = R ( τ / {β}^{2} ) ( I + ( τ / {β}^{2} ) J ) Jx ( t ) .\end{matrix} \qquad ( 28 )$$

It follows from (26)-(28) that for all t ∈ IR

u²(t)=β²+(τ/β)², u²(t)=(Rτ)²(β²(β²+(τ/β)²)/β⁴. (29)

Besides, (26) implies that the limit trajectory x(t) can be either one point or a circle. In the former case

0=x(t)=R(u(t)−x(t)),

that is, u²(t)≡β². With (29) it yields τ=0.

Now let us choose any two trajectories of the system (1)-(2) determined by the parameters (R₁, τ₁) and (R₂, τ₂) accordingly such that condition (7) is satisfied for both. Consider limit sets of these trajectories. If both limit sets are points then τ₁=τ₂=0. Otherwise their intersection is not empty.

Let us fix any point which belongs to both limit sets and consider that trajectories of the system (1)-(2), beginning at this point and determined by the parameters (R₁, τ₁) and (R₂, τ₂) accordingly. Obviously, both trajectories lie in corresponding limit sets and, for this reason, satisfy (29). But, at least at the first instant, the control u=u(x,y) should be the same and so we obtain

β²+(τ₁/β)²=β²+(τ₂/β)²

thus, τ₁=τ₂. It follows that x (0), y (0) are the same for both trajectories, and we can conclude that u(0) must be the same too. By this way we obtain from (29) that

(R₁τ₁)²(β²+(τ₁/β)²)/β⁴=(R₂τ₂)²(β²+(τ₂/β)²)/β⁴.

hence R₁=R₂. Thus, the Lemma is proven.

Proof of Lemma 2.

It can be easily seen that on any limit trajectory of the system (1)-(2), (8)-(9) τ_{d}=const. Hence we get for a limit trajectory of this system:

u²(t)=β²+(τd/β)², u²(t)=(\hat{R}τd)²(β²+(τ/β)²)/β⁴. (30)

On the other hand, the condition (29) is valid for any control locally stabilizing (1)-(2). Comparison of (30) with (29) yields that the control (8)-(9) can stabilize they system only if τ_{d}=τ, \hat{R}=R. Thus, the Lemma is proven.

Proof of Lemma 3.

The equations (15), (16) can be easily checked by differentiation.

Proof of Theorem 4. Let us denote

$$U ( ω , R ) = \frac{1}{\sqrt{{R}^{2} + {ω}^{2}}} [ \begin{matrix}R & ω \\ - ω & R\end{matrix} ] .$$

According to (11),(14), change of u at “switch moment” tₗ can be expressed as

$$u ( {t}_{i} + 0 ) = \frac{{v}_{i}}{{v}_{i - 1}} {U}^{- 1} ( {ω}_{i} , \hat{R} ) U ( {ω}_{i - 1} , \hat{R} ) u ( {t}_{i} - 0 ) .$$

In combination with (15) it implies

$${x}_{i} = x ( {t}_{i} ) - \frac{R}{\sqrt{{R}^{2} + {ω}_{i}^{2}}} U ( {ω}_{i} , R ) u ( {t}_{i} + 0 ) = \\ = x ( {t}_{i} ) - \frac{R}{{R}^{2} + {ω}_{i}^{2}} \frac{{v}_{i}}{{v}_{i - 1}} U ( {ω}_{i} , R ) {U}^{- 1} ( {ω}_{i} , \hat{R} ) . \\ . U ( {ω}_{i - 1} , \hat{R} ) u ( {t}_{i} - 0 ) = \\ = {e}^{- R ( t - {t}_{i - 1} )} {x}_{i - 1 -} \frac{R}{\sqrt{{R}^{2} + {ω}_{i - 1}^{2}}} ( V ( {ω}_{i} , \hat{R} , R ) . \\ . {V}^{- 1} ( {ω}_{i - 1} , \hat{R} , R ) - I ) U ( {ω}_{i - 1} , R ) u ( {t}_{i} - 0 ) ,$$

where I is the identity matrix,

$$V ( ω , \hat{R} , R ) = \frac{R \sqrt{{\hat{R}}^{2} + {ω}^{2}}}{\hat{R} \sqrt{{R}^{2} + {ω}^{2}}} U ( {ω}_{i} , R ) {U}^{- 1} ( {ω}_{i} , \hat{R} ) .$$

It is easy to check that, give (19), V=I+O (δ_{id}) hence

|xᵢ|<|xᵢ₋ₗ|e^{-R(t-t}_{ᵢ₋ₗ}⁾O(δ_{id}). (31)

Applying (3 1) repeatedly, we obtain

|xᵢ|<|x₁|e^{-Rt}+O(δ_{id}).

The statement of Theorem now follows immediately from (15), (16).

Proof of Theorem 5. It follows from Lemma (3) and condition (22) that on the first “step” [t₁, t₂] the value |d−y| decreases quasilinearly as

$$\frac{\hat{R} {v}^{2} {ω}_{0}}{{R}^{2} + {ω}_{i}^{2}} > \frac{{RR}_{max}}{{R}_{min}^{2}} \frac{{\hat{R}}_{0}^{2} + {ω}_{0}^{2}}{{R}^{2} + {ω}_{i}^{2}} ( {δ}_{τ} + {δ}_{2} ) > ( {δ}_{τ} + {δ}_{2} ) .$$

Occasionally y(t) will reach d, therefore t₂<∞,

Let us rewrite (1) in the form:

$$\frac{ⅆ}{ⅆ t} ( x - u ) = - R ( x - u ) - u + {ξ}_{1} . \qquad ( 32 )$$

It follows immediately from (32),(6),(11),(21) that for any t≧t₂

|x(t)|−β|≦|x(t)−u(t)|≦

≦e^{-R(t-t}_{₂}⁾|x(t₂)|+∫ₜ_{₂} ^{t}e^{-R(t-s)}(u|+|ξ₁|)ds|

≦e^{-R(t-t}_{₂}⁾|x(t₂)−u(t₂)+(ω_{*}β+δ₁)/R.

Thus, the statement (23) is proven.

On the other hand, it is easy to derive from (32), (11), (21) the dynamics of the motor starting from the moment t₂:

x(t)−u(t)=e^{-R(t-t}_{ₗ}⁾(x(tᵢ)−u(tᵢ))−zᵢ(t)++e^{-R(t-t}_{ₗ}⁾zₗ(tₗ)+∫^{t}ₜ_{ₗ}e^{-R(t-s)}ξ₁(s)ds,

where for i≦2

$${z}_{i} ( t ) = \frac{{ω}_{i} β}{{R}^{2} + {ω}_{i}^{2}} [ \begin{matrix}- R & {ω}_{i} \\ {ω}_{i} & R\end{matrix} ] [ \frac{sin ( {ω}_{i} ( t - {t}_{i} ) + {σ}_{i} )}{cos ( {ω}_{i} ( t - {t}_{i} ) + {σ}_{i} )} . ]$$

For any even i, we obtain from (3), (21), (22)

|y(t)−d|≦ε+δ₃, t ∈[tᵢ, tᵢ₊₁]. (33)

Now let us fix any odd i. If follows from (22) that

$$- sign ( ⅆ - \hat{y} ( {t}_{i} ) ) {u}^{T} ( t ) {Jz}_{i} ( t ) = \frac{ω * {β}^{2} R}{{R}^{2} + {ω}_{*}^{2}} > \\ > {δ}_{τ} + {δ}_{2} + {βδ}_{1} + \frac{1}{2} \frac{ω * {β}^{2} R}{{R}^{2} + {ω}_{*}^{2}} ,$$

therefore any t ∈[tₗ, tᵢ₊₁]

sign(d−ŷ(tᵢ))y(t)≧sign(d−ŷ(tᵢ))u^{T}(t)J(x(tᵢ)−u(tᵢ))−δ_{τ}−δ₂≧

$$\frac{ω * β R}{{R}^{2} + {ω}_{*}^{2}} - {e}^{- R ( t - {t}_{i} )} \vert u ( t ) \vert ( \vert x ( t ) - u ( t ) \vert + \vert z ( {t}_{i} ) \vert ) - {δ}_{τ} - {δ}_{2} - {βδ}_{1} .$$

Recall that at the moment tₗ the condition (33) is valid. Besides, starting from some moment,

|x(t)−u(t)<(2βω_{*}+δ₁)/R.

Thus for any odd i big enough and for any t ∈[t₁, tₗ₊₁]

$$\vert y ( t ) - d \vert < ϵ + {δ}_{3} + ( 3 {β}^{2} {ω}_{*} + {βδ}_{1} ) / {R}^{2} - \frac{1}{2} \frac{{ω}_{*} {β}^{2} R}{{R}^{2} + {ω}_{*}^{2}} t \qquad ( 34 )$$

The statement (24) easily follows from (33),(34). Thus the Theorem is proven.

1. A method for controlling an induction motor comprising the steps of:
a) measuring the velocity of a rotor of an induction motor to be controlled;
b) estimating a value of the resistance of said rotor and a value of the load torque of said motor from said rotor velocity;
c) employing said estimated values of resistance and load torque to generate parameter values for controlling first and second harmonic signal generators;
d) supplying a control signal to said motor from said first harmonic signal generator while updated parameters are supplied to said second harmonic signal generator;
e) supplying a control signal to said motor from said second harmonic signal generator while updated parameters are supplied to said first harmonic signal generator; and
f) repeating steps d) and e) to control operation of said motor.
